(19) United States
(12) Patent Application Publication
(10) Pub. No.: US 2016/0034619 A1
(43) Pub. Date: Feb. 4, 2016

(54) Systems and Methods for Comparative Analysis

(71) Applicants: Friedrich William Peyerl, Centennial, CO (US); Victor S Khangulov, Jersey City, NJ (US)

(72) Inventors: Friedrich William Peyerl, Centennial, CO (US); Victor S Khangulov, Jersey City, NJ (US)

(21) Appl. No.: 14/817,069

(22) Filed: Aug. 3, 2015

Related U.S. Application Data
(60) Provisional application No. 62/032,512, filed on Aug. 1, 2014.

(51) Int. Cl. G06F 17/50; G06F 17/18

(52) U.S. Cl. CPC G06F 17/5009; G06F 17/18

(57) ABSTRACT

This disclosure relates to data analytics. The disclosed systems and methods allow for users to access one or more databases stored in a system. The user can input information into the system relating to one or more specimens that will allow the system to perform comparative analytics on the one or more specimens. The disclosed systems and methods allow for the prediction of behaviors of specimens based on information stored in the database.

This application claims the benefit of priority of U.S. Provisional Application 62/032,512, which was filed on Aug. 1, 2015, the contents of which are incorporated in their entirety.

### FIELD

This disclosure relates generally to the field of data analytics.

### BACKGROUND

Medical decision making is complex and often needs to be customized to match an individual patient's health profile. These complexities are incompletely addressed with randomized controlled trials. In the last five years, the adoption and implementation of comprehensive electronic medical records has grown rapidly resulting in a growing body of data for use in comparative effectiveness research (CER). Observational studies (e.g., retrospective studies) using large computerized databases with up to billions of data points offer a cost-effective approach to conducting CER in real-world settings, without subjecting patients to additional medical risk.

However, there are several drawbacks to the use of large databases. First, analyzing such large amounts of data to identify patterns in large datasets can lead to false correlations. Second, sorting through the large amounts of data and properly categorizing the data to reach useful conclusions is very difficult. Third, there are large amounts of data that are not shared between researchers, clinicians, and academics. Fourth, many professionals who would most likely benefit from access to large data sets and the analyses that flow from these data sets lack the statistical and analytical tools to make use of this large data. These are just a few of the issues associated with analyzing large amounts of data (see, e.g., Marcus, Gary and Davis, Ernest. (2014, Apr. 7). Eight (No, Nine!) Problems With Big Data. The New York Times, p. A23). As a result of these many issues, CER remains confined to academia, contract research organizations, and specialized consulting firms—thereby, limiting the value of CER.

There remains a need for user-friendly systems that allow professionals to access large data sets. In addition, there remains a need for systems that allow professionals to draw conclusions based on information in the systems, even if the professionals lack a statistics or information technology background.

### SUMMARY

Disclosed herein are systems and methods that allow for user-friendly access to data and data analysis. The disclosed systems and methods can allow for individuals to access databases and the information stored in such databases through web-based applications. The systems and methods further allow for categorizing and analyzing population data to model how a specimen, sample from a group, or group of specimens behaves under certain conditions. Users can also input specific parameters to determine how the system categorizes a specimen that the user wants to be analyzed. In certain embodiments, the disclosed systems and methods are useful in the health field when analyzing patient data for CER studies and identifying the risks/benefits of particular therapeutic interventions.

Aspects of the disclosed herein include methods of real-time behavioral modeling of a specimen. As used herein, “specimen” means an individual compound, biochemical product, biologic, manufactured product, organism, human, patient, or other member of a group. The term “specimen” includes any member of a population in which data can be collected and stored for future analysis.

In certain embodiments, the methods comprise storing information relating to a plurality of specimens in a database located on a storage device. In other embodiments, the methods comprise pre-determining at least one characteristic for the plurality of specimens stored in the database and categorizing the plurality of specimens into one or more populations. The pre-determining of the at least one characteristic can be performed prior to a user inputting information relating to a specimen to be analyzed. In some embodiments, the methods comprise identifying a characteristic for the specimen and categorizing the specimen into the population whose plurality of specimens are similar to the specimen based on the characteristic. In still other embodiments, the methods comprise accessing the storage device through a network interface, upon receiving the input from the user relating to the specimen. The storage device can be connected to one or more servers. In particular embodiments, the methods comprise calculating a predicted behavior of the specimen when exposed to a condition specified by the user, the prediction being based on the input of the user and information in the database.

The methods disclosed herein can also comprise providing a user with a model of the behavior of the specimen when exposed to a condition. The model can be expressed as a statistical outcome. In some embodiments, the model provides the user (e.g., clinician) with an understanding of the risks/benefits of a treatment protocol to be used for a particular patient (i.e., specimen). In certain embodiments, the methods comprise generating a model of the predicted behavior of the specimen after exposure to the condition. For instance, the predicted behavior can relate to how a specimen will react to a change in environment (e.g., temperature, pressure, atmosphere, humidity). The model can be based on information obtained from retrospective analyses of a population of specimens to which the specimen belongs. In particular embodiments, the methods comprise providing the user with the model through the network interface to a web application. As used herein, a “network interface” is a shared boundary between a user's network and the system network. One of ordinary skill in the art will understand that a computer connecting to a network can connect to the network using a network interface controller or other like component.

In certain embodiments, the methods comprise identifying a behavior based on a population analysis. The behavior can be used to predict behavior of one or more specimens. In particular embodiments, the predicted behavior is based on one or more of propensity score, initial patient selection criteria, patient demographics, hospital characteristics, comorbidities, or illness.

In some embodiments, the methods comprise allowing a user to make one or more inputs relating to a specimen to be comparatively analyzed by the system. In other embodiments, the inputs relate to one or more characteristics that describe or relate to the specimen. The characteristics can be illness, illness severity, outcomes of treatments, age, treatment center, or comorbidities. Characteristics can be an Elixhauser or Charlson Comorbidity Index. Characteristics can also be Acute Physiology and Chronic Health Evaluation, Rapid Emergency Medical Score, CKD-EPI, Sequential Organ Failure Score, and Kidney Diseases Improving Global Outcomes. In yet other embodiments, the inputs comprise a condition to which a specimen is exposed. As provided herein, the condition can be an environmental condition (e.g., temperature, air pressure, manufacturing conditions), a treatment (e.g., drug treatment, physical therapy protocol, treatment regime, hospital best practice), or any other event that has an observable effect on a specimen.

The methods disclosed herein can also comprise calculating an outcome for the specimen based on the plurality of specimens in the population. In certain embodiments, the methods comprise calculating an outcome for a population of specimens based on a calculated behavior for the population. The calculated behavior can comprise determining an average behavior for the population. The calculated behavior can comprise determining a distribution of behaviors within the population. The calculated behavior can comprise identifying a median behavior (e.g., dose of a drug where half of the population does not react and half of the population will react to the drug) for the population.

Aspects of the methods disclosed herein are performed with systems comprising a processor and a memory. The system also comprises one or more databases. Furthermore, the system can comprise one or more storage devices. The system can further comprise one or more servers. The servers can be linked indirectly or directly to a cloud-based architecture through an internet connection.

In certain embodiments, the memory is operably linked to the processor such that the processor can access and execute instructions stored on the memory. In certain embodiments, the instructions are modules that the processor accesses and executes. For example, the processor can access a module of instructions that allows the system to perform a particular task. In some embodiments, the system comprises instructions that allow the system to receive data relating to a population of specimens or to a specimen within the population. In other embodiments, the system can comprise instructions for the system to store data relating to the specimen and information relating to a plurality of specimens in the database. In still other embodiments, the system comprises instructions to pre-determine at least one characteristic for the plurality of specimens stored in the database or for a single specimen. In yet other embodiments, the system comprises instructions to categorize the plurality of specimens into one or more populations. In particular embodiments, the system comprises instructions to receive information relating to a single specimen and determine a behavior based on the population to which the specimen is categorized.

In certain embodiments, the system comprises instructions to categorize the specimen into the population whose plurality of specimens are similar to the specimen based on at least one characteristic shared between the plurality of specimens stored in the database and the specimen being analyzed. In particular embodiments, the system comprises instructions to access the storage device through a network interface upon receiving instructions from a user, the storage device being connected to one or more servers.

In some embodiments, the systems comprise instructions to calculate a predicted behavior of the specimen when exposed to a condition specified by the user, the prediction being based on the information in the database. In other embodiments, the system comprises instructions to generate a model of the predicted behavior of the specimen after exposure to the condition. In still more embodiments, the system comprises instructions to provide the user with the model through a network interface.

### BRIEF DESCRIPTION OF THE FIGURES

To further understand the systems and methods disclosed herein, reference is directed to the following brief description of the figures as well as the drawings that show exemplary embodiments of the systems and methods:

FIG. 1 is a schematic representation showing an embodiment of a system.

FIG. 2 is a schematic representation showing an embodiment of a instructions or modules of instructions that the system of FIG. 1 utilizes.

FIG. 3 is a schematic representation showing how a user provides inputs to a system and how the system interprets the inputs.

### DETAILED DESCRIPTION

### 1. Systems

Disclosed herein are systems allow for comparative assessments of one or more conditions on the behavior of specimens within a population. The comparative assessment can be based on information for a specimen provided by a user to the system. The system can use the information provided by the user to compare the specimen to a population stored in a database based on determining whether the specimen shares at least one characteristic in common with the population. The system can also compare the specimen to particular specimens in the database. Once the comparison is performed, the system can calculate a model of predicted behavior for the specimen and report the model to the user.

The system can comprise one or more databases comprising data for one or more populations of specimens. For instance, the databases can comprise data relating to patients from a clinical study. The information in the database can comprise patient vital signs (e.g., heart rate, blood pressure), biometric information (e.g., genetic information), treatment protocol, adverse reaction information, drug-drug interaction information, and any other information collected for patients (e.g., during clinical trials or during visits of patients to clinicians). In other embodiments, the databases comprise information relating to population behaviors when a condition such as a drug treatment is introduced to specimens within the population.

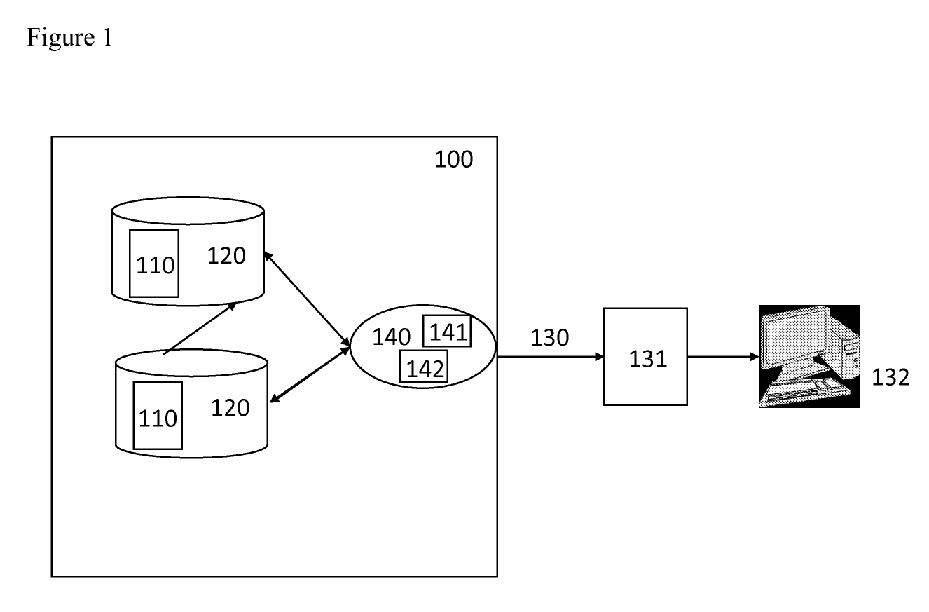

Turning to FIG. 1, the system 100 comprises a database 110. The database 110 is stored in a computer-readable storage medium 120. The system 100 further can further comprise a computer-readable storage medium 120. The computer-readable storage medium can exist as off-line storage medium, as well as primary, secondary, or tertiary storage mediums. Examples of computer-readable storage medium include CD-ROM, CD-RW, DVD-RW, DDS, hard disk drive, mass storage device, removable media drive, and robotic storage libraries.

The system 100 further comprises a connection 130 to a network 131. The network 131 allows for a user 132 to access the system 100. The user 132 can access the network through a web browser (not shown). The user 132 can access the system 100 through a web application that allows the user 132 to provide inputs to the system 100.

In certain embodiments, the web application prompts the user to provide information relating to the specimen to be analyzed. For instance, the web application asks the user to provide pertinent characteristics relating to the specimen. In the case of a clinician treating a patient, the clinician can be asked to provide the patient's age, gender, weight, illness, illness severity, and other medical history. The web application allows for the user to receive information from the system relating to a predicted behavior. The information sent from the system can be accessed as an HTML, a PDF, a JPEG, or other electronic document

Furthermore, the system can comprise security to ensure that only authorized users can access sensitive data. Encryption techniques are known to those of ordinary skill in the art. Examples of encryption include Sophos SafeGuard Enterprise Encryption 7 and Vormetric Transparent Encryption.

The system 100 may comprise one or more servers 140, each of which comprise a processor 141 and memory 142. The servers 140 provide a network interface between the user and the system 100. In addition, network interfaces can be established between devices within the system. The servers 140 also provide a network interface between other computers (not shown) in the system 100 and the computer-readable storage medium 120. The system 100 may also comprise one or more computers (not shown), each of which can also comprise a processor and memory.

As shown in FIG. 1, the system 100 comprises executable instructions located on the servers 140 or other computers in the system 100. The instructions can be modules of instructions that allow the system to perform certain tasks. Regarding the operation of the system 100, the processor 141 executes the instructions.

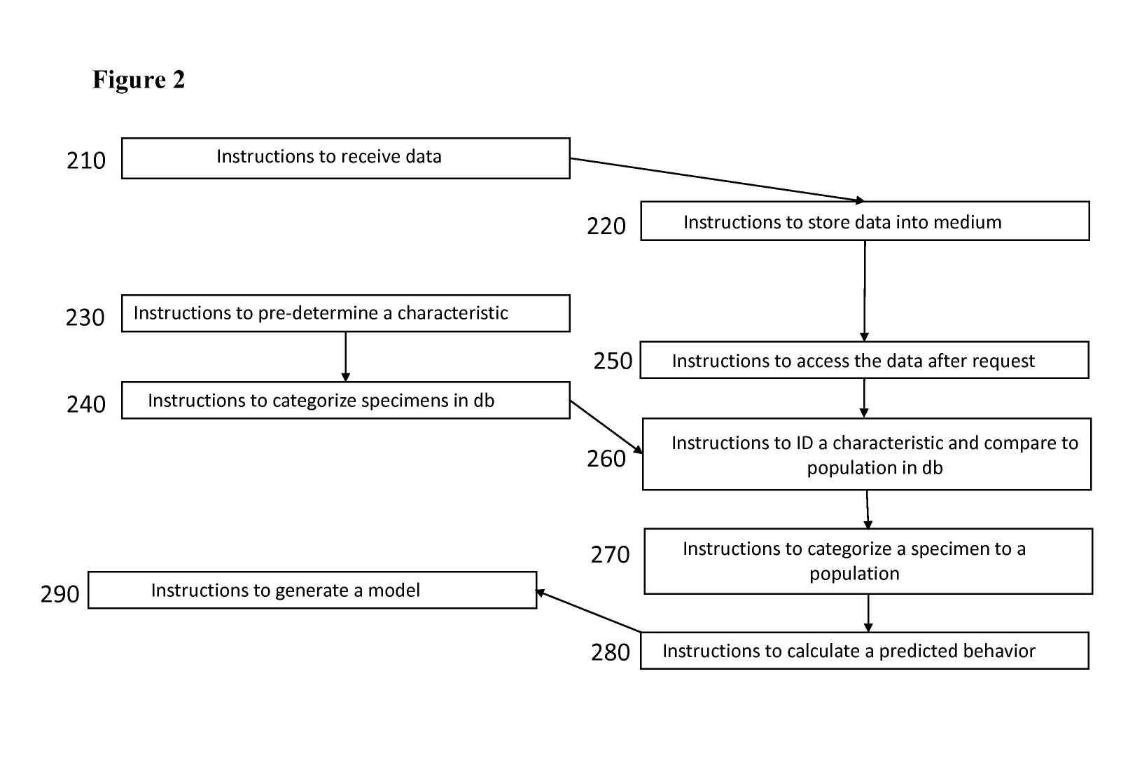

FIG. 2 shows the instructions that the system 100 of FIG. 1 comprises. The system 100 comprises instructions 210 that allow the system 100 to receive information (e.g., data) relating to specimens within a population. The instructions 210 allow a user or administrator to upload or input information from one or more studies into a database in the system 100. The database can be continually updated with information inputted from users or administrators relating to individual specimens or populations of specimens. In certain embodiments, the studies are clinical trials. In some embodiments, the studies are retrospective studies. In other embodiments, the studies relate to information generated from studies of populations of specimens.

The system 100 further comprises instructions 220 that allow the system to store uploaded or inputted information into a computer-readable medium. The stored data can be used to generate models relating to the behavior of the populations of specimens or to user inputted information relating to specimens. The system 100 also comprises instructions 230 that allow the system to pre-determine at least one characteristic for the plurality of specimens stored in the database.

For example, the system 100 can identify the dose of a drug from data in a clinical trial in which the average patient shows a particular response to the drug. The system 100 can also identify other characteristics to create subpopulations of patients in the study such as age, gender, weight, and genetic factors. The system 100 also has instructions 240 that categorize a plurality of specimens into populations based on the identified characteristic. The characteristic can also be applied to the population as a whole and can be used to predict the reaction of subsequent patients to the drug.

The system 100 also comprises instructions 250 that allow access to a storage device that comprises computer-readable storage medium after the system 100 receives instructions from a user. Access can be through a network interface.

Additional aspects of the system 100 comprises instructions 280 to calculate a predicted behavior of a specimen based on information that the user inputs into the system 100. The system 100 further comprises instructions 260 for identifying the characteristic in the specimen based on the user input and comparing the specimen to a population. The instructions 270 allow the system 100 to categorize the specimen into one or more populations to which the specimen is similar using instructions 260.

The specimen is grouped into a population and this information can be used to make inferences regarding the behavior of the specimen under certain conditions. For instance, the user can specify a condition to which a specimen is exposed or could be exposed. The system 100 utilizes information relating to populations stored in the database that are determined to have one or more similar characteristics to the specimen that the user wishes to have analyzed. The system 100 comprises instructions 290 that generate a model of the behavior that a specimen or population of specimens will exhibit based on the information relating to the population stored in the system 100. The system 100 allows a user to modify the model by inputting more information relating to the specimen at issue or the population.

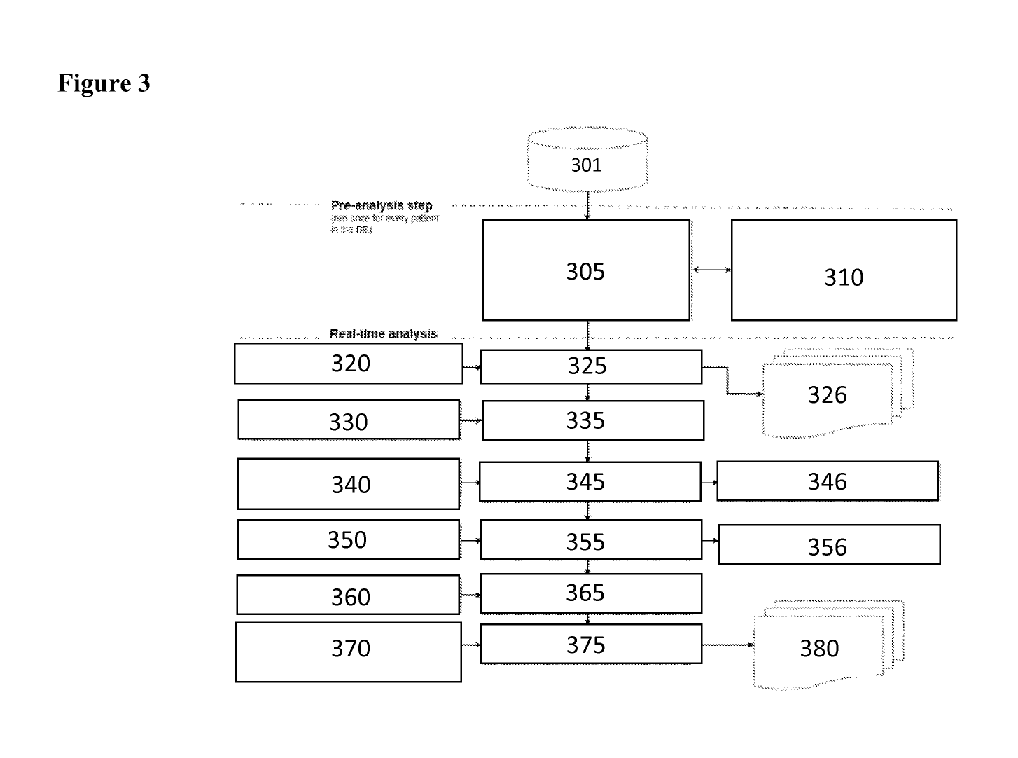

The model generated by the system can be a statistical calculation of the likelihood of an behavior. The model can also be based on algorithms that calculate the potential outcomes based on population analyses. FIG. 3 shows how one such model can be generated. The system 100 comprises a full patient database 301. The system 100 receives patient descriptors 305 such as patient demographics, hospital characteristics, comorbidities of patients, the type of illness, and the severity of the illness. In certain embodiments, the system 100 pre-calculates patient descriptors such as APACHE II, REMS, CKD-EPI, and prior therapies. The system 100 further executes instructions for validation of the pre-calculated patient descriptors 310. In particular embodiments, the pre-calculating and validation of patient descriptors is performed at least one time per patient.

The system 100 can perform a real-time analysis of a specimen or population based on the inputs of a user. In the example of FIG. 3, the user provides information relating to a patient. The user provides the information through a secured web portal that allows only authorized users access to the system (e.g., requires password identification of the user). The web portal prompts the user to provide information that will allow the system to perform the process and validation steps shown in FIG. 3.

As shown in FIG. 3, the system receives an initial patient inclusion exclusion 325 when the user specifies certain inclusion and exclusion criteria 320. These criteria are uploaded into the system 326. The criteria 320 can be stored in a comma separated values (CSV) data file, written to a common location where core analysis software (not shown) can access it. The file can contain a set of variables, criteria and relational timing information between these variables (e.g., patients≦18 on IV ketorolac with severe acute pain 48-hours after total knee arthroplasty). The portable nature of a text file allows for the data to be easily read in by the appropriate process which will construct the necessary query. The generated process (implemented using SAS for example) will query the main database and create a subset of the data that fits the selected criteria. To select patients using inclusion/exclusion criteria, the systems can utilize PROC SQL statements (SAS). In certain embodiments, the systems comprise algorithms that reduce the processing time when accessing the main database to manageable scale (i.e., <2 minutes).

The system 100 generates baseline statistics. In some embodiments, the system 100 allows users to select the preliminary set of demographics, comorbidities, and outcomes to display after selecting the patient population. In some embodiments, the selections are passed to a code analysis module (not shown) via a text file generated by the user interface. In certain embodiments, the file will include the variables to be displayed and the statistics for each. In particular embodiments, the system 100 allows the user to make a selection from predefined clinical outcomes such as mortality, readmission rates, length of stay, organ-specific complications (e.g., neurologic complications, heart failure, respiratory failure, acute renal failure), MACE (major adverse cardiac events), SOFA (Sequential Organ Failure Assessment), ventilator support, acidosis/electrolyte imbalances, and coagulopathy.

Returning to FIG. 3, the user can also specify treatment options 330, which the system 100 uses along with the inclusion and exclusion criteria to assign the patient to a particular treatment group 335. The treatment options include therapies such as chemotherapies, conservative therapies, physical therapy, and experimental therapies in clinical trials. The user also provides parameters 340 that are used in the calculation of a propensity score 345. The system performs a validation 346 of the propensity score 345 to ensure that the score is accurate.

The propensity score 345 is used to reduce bias from observable covariates. The disclosed systems and methods can implement calculation of the propensity score 345 based on the patient demographics, hospital characteristics and patient's comorbidities. The propensity score represents the probability that a patient will receive treatment, i.e., TX=1. In certain embodiments, the user selects the specific parameters to be included in the logistic regression to calculate the propensity score 345. The routine can be implemented in SAS using PROC LOGISTIC procedure with the backward selection option. To validate 346 the propensity score 345, the user can be presented with standard set of statistics that describe the goodness-of-fit, such as maximum likelihood estimates, odds ratio estimates with Wald confidence limits, and observed responses (Sommers' D, Gamma, Tau-a, Tau-c).

In addition to the propensity score matching, the systems can implement instrumental variable (IV) analysis. IVs are used to control for confounding in observational studies. It is a factor that is assumed to be related to the exposure of a specimen to a condition, but not to the observable outcome. As such, the IV can generate variation in the exposure parameters which can then be applied to adjust the model for the selection bias. In certain embodiments, the implementation of IV allows users to select from a set of variables that are related to the prescriber/treatment preference. The preference for the selected treatment can be identified on the basis of a physician, hospital or geographic region.

In particular embodiments, the system 100 evaluates associations between the instrument and treatment selection to estimate how well the instrument is predicting the treatment choice. A strong relationship between the two indicates a potentially robust selection of IV. To test for the independence of the instrument, the system 100 can comprise instructions to assess the relationship between the instrument and the observable factors by stratifying the data by patient demographics and baseline characteristics using the preference instrument. Small differences between the groups will indicate that the instrument is unrelated to the observables. The differences that are statistically significant, point to possible violations of the independence assumption.

The system 100 can implement the IV analysis as a two-stage model using the Qualitative and Limited Dependent Model (QLIM) procedure in SAS/ETS. In certain embodiments, the system 100 allows the user to select the specific patient demographics, comorbidities, hospital characteristics and severity-of-illness measures that are to be included in each stage of the regression.

In further embodiments, the system 100 allows for the user to select a matching algorithm 350. The algorithm is used to match patients within a population based on the user selection of the matching algorithm 350, which the system uses to perform matching of the specimen within the population 355. In certain embodiments, the system validates the matching of the specimen 356. In particular embodiments, the user selects nearest neighbor, caliper, Mahalanobis metric or other known analyses. In certain embodiments, the processor executes instructions to match patients based on the propensity score and the selected matching algorithm. In more embodiments, the processor executes instructions to validate the match using one or more statistical tests such as student's t-test, chi² test, or other known tests. In addition, statistical analyses can include mean analyses, standard deviation, standard error, medians, and ranges.

The system 100 allows users to select the number of matches to carry out, based on the propensity score 345. In some embodiments, the system 100 use the algorithm that has been previously published and used extensively by other studies to carry out 1:N matching 355 (see, e.g., Parsons L S. SUGI 29. 2004:1-11). The published SAS macro performs 1:N case-control matches using a greedy algorithm, i.e., once the match is made, it will not be reconsidered. The algorithm makes the “best” matches first and “next-best” matches next in a hierarchical sequence until no more matches can be made. The algorithm starts the matching using 8 digits of the propensity score, for those that are not matched in the first round, the algorithm attempts to match them on 7 digits of the propensity score. The program proceeds sequentially to the lowest digit match.

The system 100 allows the user to request and to access outcomes 360 that the system 100 determines based on information stored in the databases. The system utilizes the outcomes selected by the user to make a prediction 365 based on the selected outcomes 360. In FIG. 3, outcomes can include likelihood of success of certain treatments of a particular disease, outcome probabilities based on patient demographics, and outcomes based on hospital characteristics. In particular embodiments, the user requests and/or adjusts a model from the 370. The system 100 calculates the likelihood of the requested outcomes 375.

In certain embodiments, the system 100 comprises instructions to communicate the outcomes (e.g., model of behavior) to the user 380. The outcomes can be encrypted to ensure that only authorized users access the information. Furthermore, the network interface that allows access can be implemented through languages and algorithms known in the art. For instance, the network interface can comprise Python computer language in combination with Django. One of ordinary skill in the art will recognize that these computer languages are examples of languages that can be used and other languages are readily available. These languages are readily available modules that allow for a communication with SAS packages.

As noted herein, the models can be generated using available statistics. Such statistics include statistics for continuous parameters such as mean, standard deviation, median, and range. For categorical variables, frequency and percentage of the total population can be used. In certain embodiments, the user selects statistical analyses using software packages. One example of such software is SAS software (PROC FREQ, PROC MEAN, PROC TABULATE) on the user selected parameters, generating a set of CSV files that can be readily loaded into the network interface and presented to the user. In some embodiments, user selected outputs can be presented as histogram distributions (PROC UNIVARIATE, PROC SGPLOT) in an image format (Using SAS Output Delivery System (ODS)), which will be allowed to be called forth by the user in the interface.

Aspects of the systems disclosed herein include providing the generated model to the user. In certain embodiments, the systems provide the model in the form of a report. For instance, the disclosed systems allow the user to request that a final report be generated. In some embodiments, the final report adheres to the standards set out by the STROBE organization. The report can include title, introduction, methods, results, and/or discussion sections. In certain embodiments, some of the data will need to be entered by the user, such as background and objectives. In other embodiments, the report will be generated based on the selections made during the analysis. In some embodiments, standard language is used to describe the methodology and any limitations of the analysis. In the case that the analysis had generated warnings about the approach or failed statistical tests, these warnings can be included in the final report. For the software prototype, the Output Delivery System (ODS) is utilized and is integrated within SAS 9.3 to generate a PDF report. For the final web-based tool, the report can be generated using PHP or Java programming languages.

### Analytical Methods

Aspects of the disclosed methods allow for behavioral modeling of a specimen. In particular embodiments, the methods allow for real-time behavioral modeling of a specimen. The methods also allow for the analysis of any specimen that can be grouped into a population and from which data from a population can be obtained. Exemplary specimens include organisms, biological molecules, compounds, patients, and manufactured products.

The disclosed methods allow users to access a system in which information relating to specimens and populations of specimens are stored. The methods comprise storing information relating to a plurality of specimens in a database in a computer-readable storage medium located on a storage device. In some embodiments, the storage device is located on a server or computer. The user can upload information relating to a specimen or population of specimens for storage.

The methods further can comprise pre-determining at least one characteristic for the plurality of specimens stored in the database. In certain embodiments, the methods comprise categorizing the plurality of specimens into one or more populations. In particular embodiments, the specimens are categorized based on information that the user inputs into the system. The information can include characteristics of the specimens. Exemplary characteristics include illness, illness severity, outcomes of treatments, age, treatment center, and comorbidities. The characteristics can include Elixhauser and Charlson comorbidity indices, and hospital characteristics.

In some embodiments, the methods comprise the disclosed systems pre-determining a characteristic of a population prior to a user providing an input to the system relating to a specimen to be analyzed. The methods allow for the disclosed systems to use information stored in one or more databases in the system to pre-determine a characteristic of a population.

Aspects of the methods disclosed herein also comprise accessing a storage device. The storage device can be accessed through a network interface when the storage device is connected to one or more servers through a network connection. In certain embodiments, the system accesses a database through a network interface.

In certain embodiments, the disclosed methods involve the system calculating a predicted behavior of the specimen. In certain embodiments, the behavior is calculated based upon the specimen being exposed to a condition specified by the user. Exemplary conditions include drug-drug interactions, drug treatments, treatment protocols, environmental insults (e.g., temperature, humidity, alcohol exposure), and other adjustments to the state of the specimen. For example, a user can specify that a patient has been exposed to a drug. Based on this input, the system would access the stored databases to determine whether information relating to the drug or similar drugs was stored in the databases. For instance, the system would seek clinical trials or retrospective studies relating to the drug. The system could also review the databases for analyses predicting how a patient would react to the drug (i.e., predicted behavior) stored in the system.

In particular embodiments, the methods comprise calculating a predicted behavior by categorizing information inputted by user relating to a specimen or plurality of specimens into a population stored in the database. Once the specimen or plurality of specimens are categorized into a population, information relating to the population can be accessed by the system. If a behavior can be calculated by the system, then the system generates a model of the predicted behavior and provides the model to the user.

An example of the disclosed method in practice is provided herein. A clinician has a 38 year old male patient. The user accesses the system and inputs information regarding the patient. The clinician inputs the patient's gender age, heart rate, blood pressure, analyte measurements, and medications. The system accesses the databases stored on the computer-readable storage medium and categorizes the patient into a population created by the system. The system compares the patient to a comparator patient in the population or to an average patient in the population. The system generates a model for how the patient will react to a particular treatment.

The system in the above example can provide the clinician with the risks/benefits associated with the treatment. In other embodiments, the system would provide the clinician with the expectations for the outcome of the treatment based on the patient characteristics as compared to comparator patients in the population.

### Equivalents

Those skilled in the art will recognize, or be able to ascertain, using no more than routine experimentation, numerous equivalents to the specific embodiments described specifically in this disclosure. Such equivalents are intended to be encompassed in the scope of the following claims.

What is claimed:

1. A method of real-time behavioral modeling of a specimen-of-interest, the method comprising:
(a) storing information relating to a plurality of specimens in a database located on a storage device;
(b) prior to receiving an input from a user relating to the specimen-of-interest, pre-determining at least one characteristic for the plurality of specimens stored in the database and categorizing the plurality of specimens into one or more populations;
(c) identifying at least one characteristic for the specimen-of-interest and categorizing the specimen-of-interest into the population whose plurality of specimens are similar to the specimen-of-interest based on the at least one characteristic;
(d) upon receiving the input from the user relating to the specimen-of-interest, accessing the storage device;
(e) calculating a predicted behavior of the specimen-of-interest based on the inputs of the user and information in the database;
(f) generating a model of the predicted behavior of the specimen-of-interest; and
(g) providing the user with the model through a network interface.

2. The method of claim 1, wherein the specimen-of-interest is a human.

3. The method of claim 2, wherein the human is a patient.

4. The method of claim 1, wherein the user accesses a network through a web browser.

5. The method of claim 1, wherein the population comprises a treatment group.

6. The method of claim 1, wherein the population has been treated with a drug.

7. The method of claim 1, wherein the characteristic comprises at least one of illness, illness severity, outcomes of treatments, age, treatment center, or comorbidities.

8. The method of claim 1, wherein the behavior is selected from the group consisting of treatment outcome, drug-drug interactions, adverse treatment effects, survival odds, and combinations thereof.

9. The method of claim 1, wherein the input comprises at least one behavior selected by the user.

10. The method of claim 1 further comprising receiving a request from the user to adjust the model.

11. The method of claim 1, wherein the input comprises treatment options specified by the user.

12. The method of claim 1, wherein the input comprises one or more characteristics relating to the specimen.

13. The method of claim 1, wherein the specimen-of-interest is exposed to a condition.

14. The method of claim 13, wherein the condition comprises a drug, a treatment protocol, or an adjustment of an environment that the specimen-of-interest occupies.

15. The method of claim 1, wherein calculating a predicted behavior comprises calculating a propensity score.

16. The method of claim 15, wherein the predicted behavior is based on one or more of propensity score, initial patient selection criteria, patient demographics, hospital characteristics, comorbidities, or illness.

17. The method of claim 1, wherein the database comprises diagnosis codes.

18. The method of claim 1, wherein the at least one characteristic is an Elixhauser or Charlson Comorbidity Index.

19. The method of claim 1, wherein the at least one characteristic is a severity of illness measurement selected from the group consisting of Acute Physiology and Chronic Health Evaluation, Rapid Emergency Medical Score, CKD-EPI, Sequential Organ Failure Score, and Kidney Diseases Improving Global Outcomes.

20. The method of claim 1 further comprising providing the user with the risks, benefits, or outcomes associated with a treatment.

21. The method of claim 1, wherein the model is based on information relating to the behavior of the plurality of specimens in the population when the plurality of specimens is exposed to the condition.

22. The method of claim 21, wherein the model is expressed as statistical outcomes.

23. The method of claim 1, wherein categorizing the plurality of specimens into populations comprises identifying specimens whose behavior when exposed to the condition are similar.

24. The method of claim 1, wherein pre-determining at least one characteristic comprises calculating patient demographics, hospital characteristics, severity of illness, or combinations thereof.

25. The method of claim 1, wherein calculating a predicted behavior comprises calculating an outcome for the specimen based on the plurality of specimens in the population.

26. A system for real-time behavioral modeling of specimens-of-interest comprising:
a database stored on one or more storage mediums, the storage mediums being located on one or more computers;
a processor operably linked to a memory storing executable instructions, the processor executing the instructions to:
receive data relating to a specimen-of-interest;
store data relating to the specimen-of-interest and information relating to a plurality of specimens in the database;
pre-determine at least one characteristic for the plurality of specimens stored in the database;
categorize the plurality of specimens into one or more populations;
identify a characteristic for the specimen-of-interest and compare the specimen-of-interest to one or more populations stored in the databases;
categorize the specimen-of-interest into the population whose plurality of specimens are similar to the specimen-of-interest based on the characteristic;
access the storage device upon receiving a request from a user;
calculate a predicted behavior of the specimen-of-interest based on information specified by the user and on the information in the database;
generate a model of the predicted behavior of the specimen-of-interest; and
provide the user with the model through the network interface.

27. The system of claim 26, wherein the specimen-of-interest is a human.

28. The system of claim 27, wherein the human is a patient.

29. The system of claim 26, wherein the network interface is a web interface.

30. The system of claim 26, wherein the population comprises a treatment group.

31. The system of claim 26, wherein the population has been treated with a drug.

32. The system of claim 26, wherein the characteristic comprises at least one of illness, illness severity, outcomes of treatments, age, treatment center, or comorbidities.

33. The system of claim 26, wherein the behavior is selected from the group consisting of treatment outcome, drug-drug interactions, adverse treatment effects, survival odds, and combinations thereof.

34. The system of claim 26, wherein the input comprises a behavior selected by the user.

35. The system of claim 26 further comprising instructions to receive a request from the user to adjust the model.

36. The system of claim 26, wherein the input comprises treatment options specified by the user.

37. The system of claim 26, wherein the input comprises one or more characteristics relating to the specimen-of-interest.

38. The system of claim 26 further comprising instructions to calculate a predicted behavior comprises calculating a propensity score.

39. The system of claim 26, wherein the predicted behavior is based on one or more of propensity score, initial patient selection criteria, patient demographics, hospital characteristics, comorbidities, or illness.

40. The system of claim 26, wherein at least one of the one or more computers is a server.

41. The system of claim 26, wherein the at least one characteristic is an Elixhauser or Charlson Comorbidity Index.

42. The system of claim 26, wherein the at least one characteristic is a severity of illness measurement selected from the group consisting of Acute Physiology and Chronic Health Evaluation, Rapid Emergency Medical Score, CKD-EPI, Sequential Organ Failure Score, and Kidney Diseases Improving Global Outcomes.

43. The system of claim 26 further comprising instructions to provide the user with a risk, benefit, or outcome of a treatment.

44. The system of claim 26 further comprising instructions to calculate the model is based on information relating to the behavior of the plurality of specimens in the population when the plurality of specimens is exposed to the condition.

45. The system of claim 44, wherein the model is expressed as statistical outcomes.

46. The system of claim 26 further comprising instructions to identify specimens whose behavior when exposed to the condition are similar.

47. The system of claim 26 further comprising instructions to calculate patient demographics, hospital characteristics, severity of illness, or combinations thereof.

48. The system of claim 26 further comprising instructions to calculate an outcome for the specimen based on the plurality of specimens in the population.

49. The method of claim 26, wherein the specimen-of-interest is exposed to a condition.

50. The method of claim 49, wherein the condition comprises a drug, a treatment protocol, or an adjustment of an environment that the specimen-of-interest occupies.
